(19) United States
(12) Patent Application Publication
(10) Pub. No.: US 2011/0143249 A1
(43) Pub. Date: Jun. 16, 2011

(54) FUEL CELL SYSTEM AND METHOD OF CONTROLLING THE FUEL CELL SYSTEM

(75) Inventors: Yasuhiro Izawa, Shizuoka-ken (JP); Naoki Ito, Kanagawa-ken (JP)

(73) Assignees: TOYOTA JIDOSHA KABUSHIKI KAISHA, Toyota-shi, Aichi-ken (JP); KYOCERA CORPORATION, Kyoto-shi, Kyoto (JP)

(21) Appl. No.: 13/057,541

(22) PCT Filed: Aug. 5, 2009
(86) PCT No.: PCT/IB09/06456

§ 371 Date: Feb. 4, 2011

(30) Foreign Application Priority Data
Aug. 6, 2008 (JP) 2008-203119

(51) Int. Cl. H01M 8/04

(52) U.S. Cl. 429/441

(57) ABSTRACT

A fuel cell system includes: a fuel cell; a heat exchanger that uses exhaust heat from the fuel cell to heat a fluid; and a control section that estimates the amount of heated fluid that will be consumed and controls an operating temperature of the fuel cell based on the estimated consumption amount of the heated fluid.

### BACKGROUND OF THE INVENTION

1. Field of the Invention

The present invention relates to a fuel cell system and a method of controlling the fuel cell system.

2. Description of the Related Art

A fuel cell system including a fuel cell and an heat exchanger that uses exhaust heat from the fuel cell to heat a fluid, such as water, is described in Japanese Patent Application Publication No. 2006-24430 (JP-A-2006-24430).

In order to increase the power generation efficiency of the fuel cell in the above fuel cell system, it is necessary to operate the fuel cell in a high temperature range. When the fuel cell is operated in a high temperature range, however, a metal material in an electrode joining part may be oxidized, for example, deteriorating the fuel cell.

### SUMMARY OF THE INVENTION

The present invention provides a fuel cell system in which deterioration of a fuel cell is suppressed.

A first aspect of the present invention provides a fuel cell system including: a fuel cell; an heat exchanger that uses exhaust heat from the fuel cell to heat a fluid; and a control section that estimates an amount of the heated fluid that will be consumed and controls an operating temperature of the fuel cell based on the estimated consumption amount of the heated fluid.

According to the thus configured fuel cell system, deterioration of the fuel cell can be suppressed.

In the first aspect, the control section may control the fuel cell such that the fuel cell is controlled to generate power in one of a low-power generation efficiency mode, in which the operating temperature of the fuel cell is set within a low-temperature range, and a high-power generation efficiency mode, in which the operating temperature of the fuel cell is set within a temperature range higher than the low temperature range, and the fuel cell is controlled to generate power in the low-power generation efficiency mode when the estimated consumption amount of the heated fluid is high.

With this configuration, it is possible to suppress reduction in the total efficiency and deterioration of the fuel cell.

In the first aspect, a combustion section that mixes and combusts residual fuel gas and oxidation gas that remains after an electrochemical reaction, respectively, may be provided, and the heat exchanger may heat the fluid to a high temperature utilizing combustion heat generated in the combustion section.

With this configuration, the total efficiency can be improved.

In the first aspect, the fuel cell may be a solid oxide fuel cell.

The operating temperature of the solid oxide fuel cell is relatively higher than other type of the fuel cells, and deterioration of the fuel cell can be further suppressed.

In the first aspect, the control section may estimate the consumption amount of the heated fluid based on at least one of location information, date/time information, day-of-the-week information, holiday information, weather information, heated fluid consumption rate information, temperature information of the fluid before heating, and remaining amount information of the heated fluid. With this configuration, deterioration of the fuel cell can be suppressed.

In the first aspect, the control section may estimate the consumption amount of the heated fluid based on information input by a user using the heated fluid. With this configuration, deterioration of the fuel cell can be suppressed.

In the first aspect, the input information may be remaining amount excess information, which indicates a date and time when a remaining amount of the heated fluid is excessive, or number-of-users information.

In the first aspect, the fluid may be water. With this configuration, deterioration of the fuel cell can be suppressed.

Although the first aspect of the present invention is in the form of a fuel cell system as described above, the present invention may be implemented as other embodiments of an apparatus such as an exhaust heat utilization system. The present invention may also be implemented as a method invention such as a control method for a fuel cell system. Further, the present invention may be implemented in various forms such as a computer program that constitutes the method and the apparatus, a storage medium storing the computer program, and a data signal containing the computer program and embodied in a carrier wave.

In the case where the present invention is implemented as a computer program or a storage medium storing the program, the program may control the overall operation of the apparatus or may only serve the function of the present invention.

A second aspect of the present invention provides for a method of controlling a fuel cell system that includes a fuel cell and an heat exchanger that uses exhaust heat from the fuel cell to heat a fluid, the method including: estimating a consumption an amount of the heated fluid that will be consumed; and controlling an operating temperature of the fuel cell based on the estimated consumption amount of the heated fluid.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a block diagram that shows the configuration of a fuel cell system 100 according to an embodiment of the present invention; and

FIG. 2 is a flowchart of a water heating process.

### DETAILED DESCRIPTION OF EMBODIMENTS

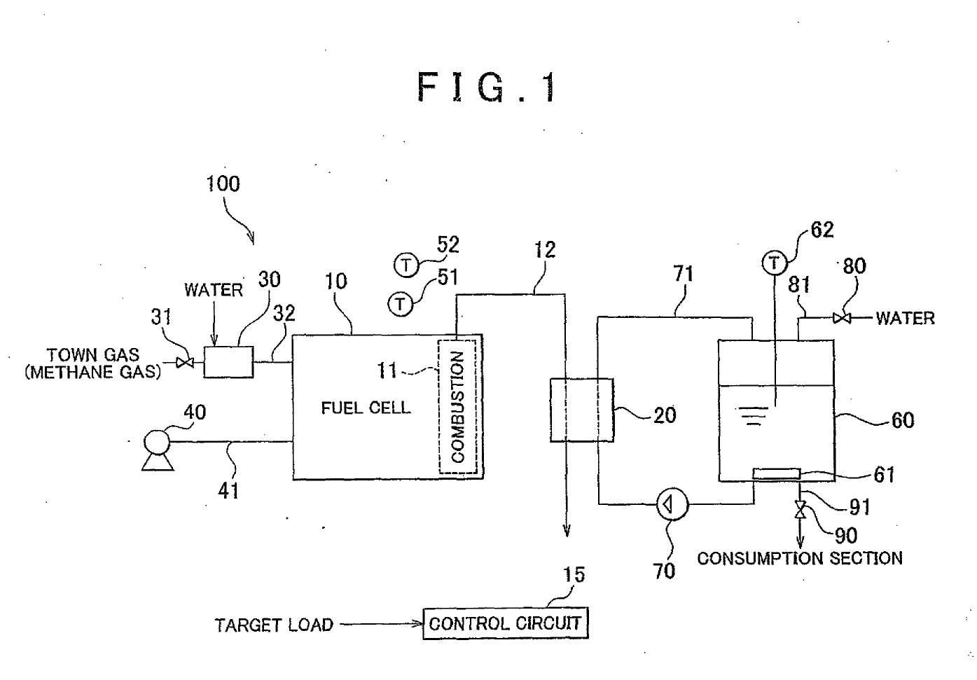

An embodiment of the present invention will be described below in the following order. A. Embodiment: A1. Configuration of Fuel Cell System: FIG. 1 is a block diagram showing the configuration of a fuel cell system 100 according to an embodiment of the present invention. The fuel cell system 100 includes a fuel cell 10, a control circuit 15, heat exchanger 20, a reformer 30, a feed gas valve 31, a blower 40, a fuel cell temperature sensor 51, an air temperature sensor 52, a hot-water tank 60, a stored water amount sensor 61, a water temperature sensor 62, a hot-water circulation pump 70, a water supply valve 80, and a hot-water discharge valve 90.

The fuel cell 10 is a solid oxide fuel cell (SOFC). The fuel cell 10 has a stack structure in which a plurality of fuel cell units (not shown) are laminated to each other. Hydrogen and carbon monoxide are introduced as a fuel gas, and air (oxygen) is introduced as an oxidation gas.

The fuel cell unit includes a membrane electrode assembly (not shown), an anode-side separator (not shown), and an electrode-side separator. The membrane electrode assembly includes an electrolyte membrane (not shown), a cathode (not shown) as an electrode, an anode (not shown), and gas diffusion layers (not shown). The membrane electrode assembly is constructed by interposing the electrolyte membrane, whose surface is formed with the electrode and the anode, between the gas diffusion layers. The fuel cell unit is constructed by further interposing the membrane electrode assembly between the anode-side separator and the electrode-side separator. For example, ion-conductive ceramics such as yttria-stabilized zirconia (YSZ) and perovskite oxide may be used as the electrolyte membrane. In addition, lanthanum manganite-based conductive ceramics may be used as the cathode. Finally, a composite material of nickel oxide and conductive ceramics such as NiO—YSZ and NiO—ScSZ may be used as the anode.

The fuel cell 10 further includes a combustion section 11. The combustion section 11 receives, mixes, and combusts residual hydrogen and air (oxygen) from the electrochemical reaction in the fuel cell 10. A high-temperature gas is generated in the combustion section 11 and then discharged into a high-temperature gas exhaust passage 12.

The reformer 30 is connected to the fuel cell 10 via a fuel gas supply passage 32. A town gas (mainly a methane gas) and water are introduced into the reformer 30, and subjected to a reforming reaction that generates hydrogen and carbon monoxide. The generated hydrogen and carbon monoxide are supplied as the fuel gas to the anodes of the fuel cell 10 via the fuel gas supply passage 32. The fuel gas supply passage 32 is provided with a feed gas valve 31 that adjusts the amount of the town gas to be introduced into the reformer 30. A water line (not shown) which is provided with a water supply pump (not shown) is connected to the reformer 30. Water used in the reforming reaction introduced into the reformer 30 is pumped through the water line.

The blower 40 is connected to the fuel cell 10 via an oxidation gas supply passage 41, and compresses and supplies the oxidation gas to the cathodes of the fuel cell 10. The blower 40 controls the amount of the air that is supplied to the fuel cell 10, and is used to adjust the fuel cell temperature of the fuel cell 10.

The fuel cell temperature sensor 51 detects the fuel cell temperature of the fuel cell 10. The air temperature sensor 52 is disposed at a position where there is no influence of heat generated by the fuel cell 10 to detect the temperature of air outside the fuel cell 10 (outside air temperature).

The hot-water tank 60 stores water. The hot-water tank 60 is connected to a hot-water circulation passage 71, a water supply passage 81, and a hot-water discharge passage 91. The water supply valve 80 is provided in the water supply passage 81, and supplies the hot-water tank 60 with water (at a relatively low temperature) when opened. The hot-water discharge passage 91 is also connected to a consumption section that is located outside the fuel cell system 100 and that consumes hot water. The hot-water discharge valve 90 is provided in the hot-water discharge passage 91, and supplied the consumption section with hot water from the hot-water tank 60 when opened.

The hot-water circulation passage 71 passes through the heat exchanger 20 (discussed later). The hot-water circulation pump 70 is provided in the hot-water circulation passage 71, and pumps hot water from the hot-water tank 60 into the hot-water circulation passage 71, through the heat exchanger 20, and back into the hot-water tank 60.

The stored water amount sensor 61 is provided near the bottom of the hot-water tank 60 to detect the amount of water stored in the hot-water tank 60 (stored water amount). The water temperature sensor 62 detects the temperature of water stored in the hot-water tank 60.

The high-temperature gas exhaust passage 12 and the hot-water circulation passage 71 pass through the heat exchanger 20 so that the respective fluids flowing through the passages exchange heat with each other. Specifically, the heat exchanger 20 allows heat exchange between the high-temperature gas flowing through the high-temperature gas exhaust passage 12 and the water flowing through the hot-water circulation passage 71. Accordingly, the water flowing through the hot-water circulation passage 71 is heated and returned to the hot-water tank 60. The water returned to the hot-water tank 60 is heated in the heat exchanger 20 and returned to the hot-water tank 60 again. In this way, the water stored in the hot-water tank 60 is repeatedly heated in the heat exchanger 20 and returned into the hot-water tank 60, at a high temperature. The high-temperature gas exhaust passage 12 discharges the exhaust gas out of the fuel cell system 100 after the gas is subjected to heat exchange in the heat exchanger 20.

The control circuit 15 is a logic circuit that includes a microcomputer. Specifically, the control circuit 15 includes a central processing unit (CPU, not shown) that executes processes in accordance with a preset control program; a read only memory (ROM, not shown) that stores control programs control data, etc., necessary for the CPU to execute various processes; a random access memory (RAM, not shown) from/to which various data necessary for the CPU to execute various processes is read/written temporarily; and an input/output port (not shown) to/from which various signals are input/output. The control circuit 15 controls the feed gas valve 31, the blower 40, the hot-water circulation pump 70, the water supply valve 80, and the hot-water discharge valve 90. When target load is given from outside the fuel cell system 100, the control circuit 15 controls the various components so that the fuel cell 10 outputs the amount of power required by the target load.

The control circuit 15 executes a water heating process (discussed later). In the water heating process, the control circuit 15 acquires the fuel cell temperature, the outside air temperature, and the stored water amount from the fuel cell temperature sensor 51, the air temperature sensor 52, and the stored water amount sensor 61, respectively.

In the water heating process executed by the fuel cell system 100 according to the embodiment, water is heated by exhaust heat from the fuel cell 10.

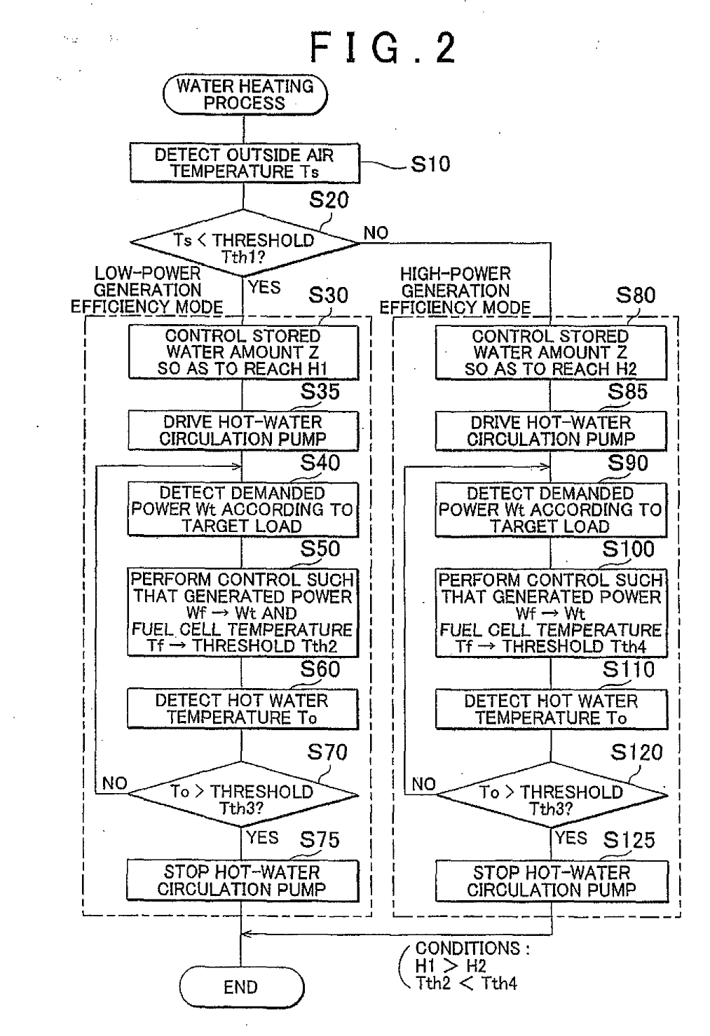

A2. Water Heating Process: FIG. 2 is a flowchart of the water heating process. The water heating process is performed after the fuel cell 10 starts generating power and when power generation by the fuel cell 10 becomes stabilized. The water heating process is performed when the following conditions are satisfied: the opening degree of the feed gas valve 31 is adjusted so that the amount of town gas required to satisfy a target load is supplied to the reformer 30; the water supply valve 80 and the hot-water discharge valve 90 are closed; and the hot-water circulation pump 70 is stopped.

In addition, the blower 40 supplies the amount of air required by the target load (at a flow rate that optimizes the power generation efficiency of the fuel cell 10).

In the water heating process, first, the control circuit 15 detects an outside air temperature Ts from the air temperature sensor 52 (step S10).

The control circuit 15 determines whether the outside air temperature Ts is below a threshold temperature Tth1 (step S20). The threshold temperature Tth1 may be determined based on the specific design of the fuel cell system 100. For example, the threshold temperature Tth1 may be set to 10° C.

If the outside air temperature Ts is below the threshold temperature Tth1 (step S20: Yes), the control circuit 15 determines (predicts) that the amount of hot water consumed is greater than normal, and executes a control in a low-power generation efficiency mode.

In the low-power generation efficiency mode, first, the control circuit 15 controls the amount of water stored in the hot-water tank 60 (stored water amount Z) to H1, which is relatively higher than the normal amount (step S30). Specifically, the control circuit 15 opens the water supply valve 80 until the stored water amount Z detected by the stored water amount sensor 61 reaches H1. The value of H1 is greater than the value of H2 for a high-power generation efficiency mode.

The control circuit 15 drives the hot-water circulation pump 70 to circulate the water in the hot-water tank 60 (step S35).

The control circuit 15 detects demanded power Wt according to a target load (step S40). Subsequently, the control circuit 15 controls power generation by the fuel cell 10 (generated power Wf) to output the demanded power Wt, and controls the temperature of the fuel cell 10 (fuel cell temperature Tf) to reach a threshold temperature Tth2 (step S50). Specifically, the control circuit 15 controls the feed gas valve 31 and the blower 40 such that the generated power Wf reaches the demanded power Wt and the fuel cell temperature Tf detected by the fuel cell temperature sensor 51 reaches the threshold temperature Tth2. The threshold temperature Tth2 is lower than a threshold temperature Tth4 (discussed later), and may be appropriately determined based on the specific design of the fuel cell system 100. For example, the threshold temperature Tth2 may be set to 700° C.

The control circuit 15 detects the temperature of the water (hot water) stored in the hot-water tank 60 (hot-water temperature To) (step S60). If the hot-water temperature To does not exceed a threshold temperature Tth3 (step S70: No), the control circuit 15 returns to step S40. The threshold temperature Tth3 may be appropriately determined based on the specific design of the fuel cell system 100. For example, the threshold temperature Tth3 may be set to 95° C.

If the hot-water temperature To exceeds the threshold temperature Tth3 (step S70: Yes), the control circuit 15 stops driving the hot-water circulation pump 70 to stop the circulation of water in the hot-water tank 60 (step S75). Thereafter, the water heating process is terminated.

If the outside air temperature Ts is equal to or above the threshold temperature Tth1 (step S20: No), on the other hand, the control circuit 15 estimates that the amount of hot water consumed is small, and executes a control in a high-power generation efficiency mode.

In the high-power generation efficiency mode, first, the control circuit 15 controls the amount of water stored in the hot-water tank 60 (stored water amount Z) to H2, which is smaller than the normal amount (step S80). Specifically, the control circuit 15 opens the water supply valve 80 until the stored water amount Z detected by the stored water amount sensor 61 reaches H2. The value H2 is less than the value H1.

The control circuit 15 drives the hot-water circulation pump 70 to circulate the water stored in the hot-water tank 60 (step S85).

The control circuit 15 detects the demanded power Wt according to a target load (step S90). Subsequently, the control circuit 15 controls power generated by the fuel cell 10 (generated power Wf) to output the demanded power Wt, and controls the temperature of the fuel cell 10 (fuel cell temperature Tf) to reach a threshold Tth4 (step S100). Specifically, the control circuit 15 controls the feed gas valve 31 and the blower 40 such that the generated power Wf reaches the demanded power Wt and the fuel cell temperature Tf detected by the fuel cell temperature sensor 51 reaches the threshold Tth4. The threshold Tth4 is higher than the threshold temperature Tth2, and may be appropriately determined based on the specific design of the fuel cell system 100. For example, the threshold Tth4 may be set to 1000° C.

The control circuit 15 detects the temperature of the water (hot water) stored in the hot-water tank 60 (hot-water temperature To) (step S110). If the hot-water temperature To is below a threshold temperature Tth3 (step S120: No), the control circuit 15 returns to step S90.

If the hot-water temperature To exceeds the threshold temperature Tth3 (step S120: Yes), the control circuit 15 stops driving the hot-water circulation pump 70 to stop the circulation of water in the hot-water tank 60 (step S125). Thereafter, the water heating process is terminated.

For a fuel cell system that utilizes exhaust heat from a fuel cell to heat water, there has been a demand to suppress reduction in the total efficiency calculated in consideration of not only the power generation efficiency of the fuel cell but also the energy efficiency in heating water. When the fuel cell 10 is operated in a relatively high temperature range for a long period, the cathodes and the anodes may be oxidized, for example, deteriorating the fuel cell 10. The “power generation efficiency” of a fuel cell refers to the ratio of the amount of power generated by the fuel cell to the amount of heat of a fuel gas input to the fuel cell. The “total efficiency” refers to the ratio of the sum of the amount of power generated by the fuel cell and the amount of energy consumed to heat water to the amount of heat of a fuel gas input to the fuel cell.

According to the fuel cell system 100 of the embodiment if the outside air temperature Ts is below the threshold temperature Tth1, the fuel cell system 100 determines that the amount of hot water consumed is high, and executes a control in the low-power generation efficiency mode, in which the fuel cell temperature Tf is kept relatively low. In this way, the amount of exhaust heat from the fuel cell 10 (or the thermoelectric ratio) may be increased when the consumption of hot water is great. As a result, it is possible to suppress reduction in the total efficiency and deterioration of the fuel cell 10.

According to the fuel cell system 100 of the embodiment, in addition, if the outside air temperature Ts is not less than the threshold temperature Tth1, the fuel cell system 100 determines that the amount of hot water consumed is small, and executes a control in the high-power generation efficiency mode in which the fuel cell temperature Tf is maintained relatively high. In this way, the power generation efficiency of the fuel cell 10 may be increased and the thermoelectric ratio can be reduced when the consumption of hot water is small. As a result, the overall efficiency can be improved.

In the fuel cell system 100 of the embodiment, the fuel cell 10 combusts the reaction gas after being subjected to the electrochemical reaction in the combustion section 11, and the resulting high-temperature gas is used to heat water in the heat exchanger 20. In other words, combustion heat from the combustion section 11 is used to heat water in the heat exchanger 20. In this way, the total efficiency is improved.

In the embodiment, the fuel cell 10 may correspond to the “fuel cell” in the claims. The heat exchanger 20 may correspond to the “heat exchanger” in the claims. The control circuit 15 may correspond to the “control section” in the claims. In the water heating process (FIG. 2), the water present in the hot-water tank 60 before driving the hot-water circulation pump 70 may correspond to the “low-temperature fluid” in the claims. The water (hot water) present in the hot-water tank 60 after driving the hot-water circulation pump 70 may correspond to the “high-temperature fluid” in the claims. The outside air temperature Ts is used as predictive information based on which it is determined whether the consumption of hot water is great or small, and may correspond to the “predictive information” in the claims.

B. Modifications: Of the components used in the above embodiment, components other than those claimed in the independent claims are additional, and may be omitted appropriately. The present invention is not limited to the above embodiment, and may be implemented in various embodiments without departing from the scope of the present invention. For example, the present invention may be modified in the ways described below.

B1. Modification 1: In the water heating process performed by the above fuel cell system 100, whether a control is executed in either the low-power generation efficiency mode or the high-power generation efficiency mode is determined based on the outside air temperature Ts, which serves as the predictive information for estimating whether the amount of hot water consumed is great or small. However, the present invention is not limited thereto, and may be modified in various ways. For example, information indicated in (1) to (11) below may be used singly or in various combinations as the predictive information.

(1) Date/time information may be used as the predictive information. For example, in the water heating process, if the date/time information indicates a date and time from December 1 to March 31 (in winter), the fuel cell system 100 may estimate that the consumption amount of hot water is great because it is cold, and execute a control in the low-power generation efficiency mode. Meanwhile, if the date/time information indicates a date and time from April 1 to November 30 (in summer), the fuel cell system 100 may estimate that the consumption amount of hot water is small because it is relatively warm, and execute a control in the high-power generation efficiency mode. With this configuration, the fuel cell system 100 updates the date/time information or acquires the date/time information from outside. This configuration also achieves the effect of the above embodiment, at least partially. The date/time information may correspond to the “predictive information” or the “date/time information” in the claims.

(2) In the fuel cell system 100, day-of-the-week information may be used as the predictive information. For example, the fuel cell system 100 may learn, based on past heated water consumption patterns, the day of the week on which a large amount of hot water is consumed, and execute a control in the low-power generation efficiency mode if the day-of-the-week information indicates that it is the day of the week on which a large amount of heated water is consumed. However, if the day-of-the-week information does not indicate that it is the day of the week on which the consumption amount of heated water is great, the fuel cell system 100 may execute a control in the high-power generation efficiency mode. In this case, the fuel cell system 100 updates the day-of-the-week information or acquires the day-of-the-week information from outside. This configuration also achieves the effect of the above embodiment, at least partially. The day-of-the-week information may correspond to the “predictive information” or the “day-of-the-week information” in the claims.

(3) In the fuel cell system 100, holiday information may be used as the predictive information. For example, in the water heating process, if the date and time indicated by the date/time information falls on a holiday indicated by the holiday information, the fuel cell system 100 may predict that the consumption amount of hot water is great, and execute control in the low-power generation efficiency mode. Meanwhile, if the date and time indicated by the date/time information does not fall on a holiday indicated by the holiday information, the fuel cell system 100 may predict that the consumption amount of hot water is small, and execute control in the high-power generation efficiency mode. In this case, the fuel cell system 100 updates the date/time information or acquires the date/time information from outside, and acquires the holiday information or stores the holiday information in advance. This configuration also achieves the effect of the above embodiment, at least partially. The holiday information in the modification may correspond to the “predictive information” or the “holiday information” in the claims.

(4) Humidity information indicating the humidity outside the fuel cell system 100 may be used as the predictive information. For example, in the water heating process, if the humidity indicated by the humidity information is below a predetermined humidity, the fuel cell system 100 may estimate that the consumption amount of hot water is great, and execute control in the low-power generation efficiency mode. Meanwhile, if the humidity indicated by the humidity information is not below the predetermined humidity, the fuel cell system 100 may estimate that the consumption amount of hot water is small, and execute control in the high-power generation efficiency mode. In this case, the fuel cell system 100 detects the humidity outside the fuel cell system 100. This configuration also achieves the effect of the above embodiment, at least partially. The humidity information in the modification may correspond to the “predictive information” or the “weather information” in the claims.

(5) Discomfort index information indicating the discomfort index of the environment outside the fuel cell system 100 may be used as the predictive information. For example, in the water heating process, if the discomfort index indicated by the discomfort index information is below a predetermined index value, the fuel cell system 100 may estimate that the consumption amount of hot water is great, and execute control in the low-power generation efficiency mode. Meanwhile, if the discomfort index indicated by the discomfort index information is not below the predetermined index value, the fuel cell system 100 may estimate that the consumption amount of hot water is small, and execute control in the high-power generation efficiency mode. In this case, the fuel cell system 100 detects the discomfort index of the environment outside the fuel cell system 100. This configuration also achieves the effect of the above embodiment, at least partially. The discomfort index information in the modification may correspond to the “predictive information” or the “weather information” in the claims.

(6) Consumption rate information indicating the consumption rate of hot water in the hot-water tank 60 may be used as the predictive information. For example, in the water heating process, if the consumption rate indicated by the consumption rate information continues to be above a predetermined rate for a predetermined period, the fuel cell system 100 may estimate that the consumption amount of hot water is great, and execute control in the low-power generation efficiency mode. Otherwise, the fuel cell system 100 may estimate that the consumption amount of hot water is small, and execute control in the high-power generation efficiency mode. In this case, the fuel cell system 100 detects the consumption rate of hot water in the hot-water tank 60 and includes a timer function. This configuration also achieves the effect of the above embodiment, at least partially. The consumption rate information in the modification may correspond to the “predictive information” or the “consumption rate information” in the claims.

(7) Remaining amount information indicating the amount of hot water remaining in the hot-water tank 60 may be used as the predictive information. For example, in the water heating process, if the remaining amount of hot water indicated by the remaining amount information is less than a predetermined value, the fuel cell system 100 may estimate that the consumption amount of hot water is great, and execute control in the low-power generation efficiency mode. Otherwise, the fuel cell system 100 may estimate that the consumption amount of hot water is small, and execute control in the high-power generation efficiency mode. In this case, the fuel cell system 100 acquires the remaining amount of hot water from the stored water amount sensor 61. This configuration also achieves the effect of the above embodiment, at least partially. The remaining amount information in the modification may correspond to the “predictive information” or the “remaining amount information” in the claims.

(8) Remaining amount excess information input by a consumer of hot water (user) and indicating the date and time at which the amount of hot water remaining in the hot-water tank 60 is excessive may be used as the predictive information. For example, in the water heating process, if the date and time indicated by the date/time information falls on the date and time at which the remaining amount of hot water is indicated to be great by the remaining amount excess information, the fuel cell system 100 may estimate that the consumption amount of hot water is great, and execute control in the low-power generation efficiency mode. Meanwhile, if the date and time indicated by the date/time information does not fall on the data and time at which the remaining amount of hot water is indicated to be great by the remaining amount excess information, the fuel cell system 100 may estimate that the consumption amount of hot water is small, and execute control in the high-power generation efficiency mode. In this case, the fuel cell system 100 receives an input of the remaining amount excess information from the user and updates the date/time information or acquiring the date/time information from outside. This configuration also achieves the effect of the above embodiment, at least partially. The remaining amount information in the modification may correspond to the “predictive information” or the “remaining amount excess information” in the claims.

(9) Number-of-users information input by a consumer of hot water (user) and indicating the number of users who use the hot water may be used as the predictive information. For example, in the water heating process, if the number of users indicated by the number-of-users information is exceeds a predetermined number, the fuel cell system 100 may estimate that the consumption amount of hot water is great, and execute control in the low-power generation efficiency mode. Meanwhile, if the number of users indicated by the number-of-users information does not exceed the predetermined number, the fuel cell system 100 may estimate that the consumption amount of hot water is small, and execute control in the high-power generation efficiency mode. In this case, the fuel cell system 100 receives an input of the number-of-users information from the user. This configuration also achieves the effect of the above embodiment, at least partially. The number-of-users information in the modification may correspond to the “predictive information” or the “number-of-users information” in the claims.

(10) Location information indicating the location of the fuel cell system 100 may be used as the predictive information. For example, in the water heating process, if the location information indicates a cold place and the outside air temperature of the fuel cell system 100 is considered to be relatively low, the fuel cell system 100 may estimate that the consumption amount of hot water is great, and execute control in the low-power generation efficiency mode. Meanwhile, if the location information indicates a warm place and the outside air temperature of the fuel cell system 100 is considered to be relatively high, the fuel cell system 100 may estimate that the consumption amount of hot water is small, and execute control in the high-power generation efficiency mode. In this case, the fuel cell system 100 acquires the location information (a Global Positioning Satellite (GPS) function, for example) and a climate map corresponding to the location information. This configuration also achieves the effect of the above embodiment, at least partially. The location information in the modification may correspond to the “predictive information” or the “location information” in the claims.

(11) Low-temperature water temperature information indicating the temperature of water in the hot-water tank 60 before driving the hot-water circulation pump 70 may be used as the predictive information. For example, in the water heating process, if the low-temperature water temperature information indicates that the water temperature is below a predetermined temperature, the fuel cell system 100 may determine that more energy is required to produce hot water, and execute control in the low-power generation efficiency mode. Meanwhile, if the low-temperature water temperature information does not indicate that the water temperature is below a predetermined temperature, the fuel cell system 100 may determine that less energy is required to produce hot water, and execute control in the high-power generation efficiency mode. This configuration also achieves the effect of the above embodiment, at least partially. The low-temperature water temperature information in the modification may correspond to the “predictive information” or the “low-temperature fluid temperature information” in the claims.

B2. Modification 2: Although the fuel cell 10 is a solid oxide fuel cell in the above fuel cell system 100, the present invention is not limited to this configuration. For example, the fuel cell 10 may be a polymer electrolyte fuel cell, a hydrogen separation membrane fuel cell, an alkali fuel cell, a phosphoric acid fuel cell, or a molten carbonate fuel cell. These alternative configurations also achieve the effect of the above embodiment.

B3. Modification 3: Although the stored water amount Z remains set to H1 in the low-power generation efficiency mode and to H2 in the high-power generation efficiency mode, the present invention is not limited to these conditions, and the fuel cell system 100 may change the stored water amount Z that is set in each mode in accordance with the amount of hot water consumed by the consumption section. This configuration suppresses the possibility that there is no hot water in the hot-water tank 60.

B4. Modification 4: Although the threshold temperature Tth1 is a constant value in the fuel cell system 100, the present invention is not limited thereto. For example, the threshold temperature Tth1 may vary in accordance with the date/time information, the day-of-the-week information, the holiday information, the humidity information, the discomfort index information, the consumption rate information, the remaining amount information, the remaining amount excess information, the number-of-users information, the location information, or the demanded power Wt based on the target load in Modification 1 above. This configuration further suppresses reduction in the total efficiency and deterioration of the fuel cell 10.

B5. Modification 5: Although water is heated through the water heating process performed by the above fuel cell system 100, the present invention is not limited to this process, and a fluid other than water may be heated. For example, a heating medium may be heated.

B6. Modification 6: Although the combustion section 11 is disposed in the fuel cell 10 in the above fuel cell system 100, the present invention is not limited to this configuration, and the combustion section 11 may be disposed outside the fuel cell 10. For example, the combustion section 11 may be disposed inside the heat exchanger 20.

1. A fuel cell system comprising:
a fuel cell;
a heat exchanger that uses exhaust heat from the fuel cell to heat a fluid; and
a control section that estimates an amount of the heated fluid that will be consumed and controls an operating temperature of the fuel cell based on the estimated consumption amount of the heated fluid.

2. The fuel cell system according to claim 1, wherein the control section controls the fuel cell such that the fuel cell is controlled to generate power in one of a low-power generation efficiency mode, in which the operating temperature of the fuel cell is set within a low-temperature range, and a high-power generation efficiency mode, in which the operating temperature of the fuel cell is set within a temperature range higher than the low temperature range,
and the fuel cell is controlled to generate power in the low-power generation efficiency mode when the estimated consumption amount of the heated fluid is high.

3. The fuel cell system according to claim 1, further comprising:
a combustion section that mixes and combusts residual fuel gas and oxidation gas that remains after an electrochemical reaction, respectively,
wherein the heat exchanger heats the fluid to a high temperature utilizing combustion heat generated in the combustion section.

4. The fuel cell system according to claim 1, wherein the fuel cell is a solid oxide fuel cell.

5. The fuel cell system according to claim 1, wherein the control section estimates the consumption amount of the heated fluid based on at least one of location information, date/time information, day-of-the-week information, holiday information, weather information, heated fluid consumption rate information, temperature information of the fluid before heating, and remaining amount information of the heated fluid.

6. The fuel cell system according to claim 1, wherein the control section estimates the consumption amount of the heated fluid based on information input by a user using the heated fluid in the heat exchanger.

7. The fuel cell system according to claim 6, wherein the input information is remaining amount excess information, which indicates a date and time when a remaining amount of the heated fluid is excessive, or number-of-users information.

8. The fuel cell system according to claim 1, wherein the fluid is water.

9. A method of controlling a fuel cell system that includes a fuel cell and a heat exchanger that uses exhaust heat from the fuel cell to heat a fluid, the method comprising:
estimating an amount of heated fluid that will be consumed; and
controlling an operating temperature of the fuel cell based on the estimated consumption amount of the heated fluid.

10. The control method according to claim 9, wherein the fuel cell is controlled to generate power in one of a low-power generation efficiency mode, in which the operating temperature of the fuel cell is set within a low-temperature range, and a high-power generation efficiency mode, in which the operating temperature of the fuel cell is set within a temperature range higher than the low temperature range,
and wherein is controlled to generate power in the low-power generation efficiency mode when the estimated consumption amount of the heated fluid is high.
